(19) United States
(12) Patent Application Publication
(10) Pub. No.: US 2022/0029808 A1
(43) Pub. Date: Jan. 27, 2022

(54) System, Product and Method for Providing Secured Access to Data

(71) Applicant: Akeyless Secuirity LTD., Tel Aviv (IL)

(72) Inventors: Refael Angel, Jerusalem (IL); Oded Hareven, Rehovot (IL); Ori Mankali, Petach Tikva (IL)

(21) Appl. No.: 17/384,754

(22) Filed: Jul. 24, 2021

Related U.S. Application Data
(60) Provisional application No. 62/706,012, filed on Jul. 26, 2020.

(51) Int. Cl. H04L 9/32; H04L 29/06

(52) U.S. Cl. CPC H04L 9/3213; H04L 9/3228; H04L 67/42; H04L 63/1466; H04L 63/1416

(57) ABSTRACT

A method, apparatus and computer program product comprising a non-transitory computer readable storage medium retaining program instructions configured to cause a processor to perform actions, which program instructions implement: receiving, by a server, from a requester, a request and a token associated with a client; determining whether the token is valid, comprising determining whether the token corresponds to a stored token provided to the client at most a predetermined time period prior to said receiving; subject to a determination that the token is valid: providing to the requester a new token; storing the new token; invalidating the token; and providing the requester with access to client data stored with a third party, wherein said access is enabled by a temporary code to be used in communication with the third party; and subject to a determination that the token is invalid: issuing an attack alert to the client.

### CROSS-REFERENCE TO RELATED APPLICATION

This application is a continuation of and claims the benefit of U.S. Provisional Patent Application No. 62/706,012, filed Jul. 26, 2020, entitled “SYSTEM, PRODUCT AND METHOD FOR MAINTAINING SECURED UNIVERSAL IDENTITY” which is hereby incorporated by reference in its entirety without giving rise to disavowment.

### TECHNICAL FIELD

The present disclosure relates to securing access to data in general, and to universally maintaining identities with third parties, in particular.

### BACKGROUND

A well known problem in the art of cryptography in general, and identifying to a third party in particular is that of “secret zero”. The problem occurs when one uses a secret to protect another secret. For example, in order to protect a user password or another identifying detail from being abused or changed by a malicious party, a user may be required to provide answers to predetermined questions wherein almost always the user is the only one to know, for example “the name of your first pet”. The answers may be stored and used for authenticating the user when changing the password. However, this new “secret” now needs to be protected as well. Creating this secret chain leaves one last unprotected secret, which may be termed “secret-zero”.

It will be appreciated that the problem is not limited to user-accessed accounts or other assets, and is equally applicable to providing access by computerized platforms to other computerized platforms. In particular, the problem is also present when attempting to secure the data by encrypting it. The stolen encrypted data may be useless to an attacker, only as long as the attacker does not have access to the decryption key and decryption scheme, which again presents the same “secret-zero” problem.

### BRIEF SUMMARY

One exemplary embodiment of the disclosed subject matter is a computer program product comprising a non-transitory computer readable storage medium retaining program instructions configured to cause a processor to perform actions, which program instructions implement: receiving, by a server, from a requester, a request and a token associated with a client; determining whether that the token is valid, wherein said determining whether the token is valid comprises determining whether the token corresponds to a stored token provided by the server to the client at most a predetermined time period prior to said receiving; subject to a determination that the token is valid: providing to the requester a new token to be stored by the client and used in future communications; storing the new token; invalidating the token; and providing the requester with access to client data stored with a third party, wherein said access is enabled by a temporary code to be used in communication with the third party; and subject to a determination that the token is invalid: issuing an attack alert to the client. Within the computer program product, the temporary code is optionally to be provided by the client when communicating with the third party, whereby the client is enabled to access the third party directly without divulging a persistent access code to the third party that is usable in future connection sessions. Within the computer program product, the temporary code is optionally to be used by a proxy communicating with the third party on behalf of the client. Within the computer program product, the predetermined time period is optionally between two hours and five minutes. Within the computer program product, the client is optionally configured to initiate token update in a periodic manner at least once during the predetermined time period, wherein the token update comprises: providing a valid token to the server, invalidation, by the server, of the valid token, issuing, by the server, a second valid token, and transmitting the second valid token to the client. Within the computer program product, the client is optionally an application using a Software Development Kit (SDK) to access the server. Within the computer program product, the program instructions can further implement: upon client configuration with the server in relation with the third party, providing by the server to the client an initializer token, the initializer token to be used as the token on a first communication with the server, regarding the third party; and storing the initializer token. Within the computer program product, the program instructions can further implement: providing an initializer token to the client by a parent process configuring the client in relation with the third party, the initializer token to be used as the token on a first communication with the server, regarding the third party. Within the computer program product, the client is optionally implemented on a computing platform selected from the group consisting of: a cloud computing platform, and an on-premise computing platform. Within the computer program product, the server is optionally implemented on a computing platform selected from the group consisting of: a cloud computing platform, and an on-premise computing platform.

Another aspect of the disclosure relates to a method for authenticating a client by a server, the method comprising: receiving, by a server, from a requester, a request and a token associated with a client, the request related to accessing client data stored with a third party; upon determining that the token does not correspond to a last token provided by the server to the client, or that the last token was provided by the server to the client more than a predetermined time period prior to said receiving issuing an attack alert to the client.

Yet another aspect of the disclosure relates to a method for authenticating a client by a server, comprising: receiving, by a server, from a requester, a request and a token associated with a client; determining whether that the token is valid, wherein said determining whether the token is valid comprises determining whether the token corresponds to a stored token provided by the server to the client at most a predetermined time period prior to said receiving; subject to a determination that the token is valid: providing to the requester a new token to be stored by the client and used in future communications; storing the new token; invalidating the token; and providing the requester with access to client data stored with a third party, wherein said access is enabled by a temporary code to be used in communication with the third party; and subject to a determination that the token is invalid: issuing an attack alert to the client. Within the method, the temporary code is optionally to be provided by the client when communicating with the third party, whereby the client is enabled to access the third party directly without divulging a persistent access code to the third party that is usable in future connection sessions. Within the method, the predetermined time period is optionally between two hours and five minutes. Within the method, the client is optionally configured to initiate token update in a periodic manner at least once during the predetermined time period, wherein the token update comprises: providing a valid token to the server, invalidation, by the server, of the valid token, issuing, by the server, a second valid token, and transmitting the second valid token to the client. The method can further comprise: upon client configuration with the server in relation with the third party, providing by the server to the client an initializer token, the initializer token to be used as the token on a first communication with the server, regarding the third party; and storing the initializer token. The method can further comprise: providing an initializer token to the client by a parent process configuring the client in relation with the third party, the initializer token to be used as the token on a first communication with the server, regarding the third party.

Yet another aspect of the disclosure relates to a computerized apparatus having a processor, the processor being adapted to perform the steps of: receiving, by a server, from a requester, a request and a token associated with a client; determining whether that the token is valid, wherein said determining whether the token is valid comprises determining whether the token corresponds to a stored token provided by the server to the client at most a predetermined time period prior to said receiving; subject to a determination that the token is valid: providing to the requester a new token to be stored by the client and used in future communications; storing the new token; invalidating the token; and providing the requester with access to client data stored with a third party, wherein said access is enabled by a temporary code to be used in communication with the third party; and subject to a determination that the token is invalid: issuing an attack alert to the client. Within the apparatus, the processor is optionally further adapted to perform the steps of: receiving, by a server, from a requester, a request and a token associated with a client, the request related to accessing client data stored with a third party; upon determining that the token does not correspond to a last token provided by the server to the client, or that the last token was provided by the server to the client more than a predetermined time period prior to said receiving issuing an attack alert to the client. Within the apparatus, the client is optionally implemented on a computing platform selected from the group consisting of: a cloud computing platform, and an on-premise computing platform and the server is optionally implemented on a computing platform selected from the group consisting of: a cloud computing platform, and an on-premise computing

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic block diagram of exchanging an initial token, in accordance with some exemplary embodiments of the disclosure;

FIG. 1B is a schematic block diagram of a communication exchange between a client and an authentication serve, in accordance with some exemplary embodiments of the disclosure;

FIG. 1C is a schematic block diagram of a communication exchange between a client and an authentication server for obtaining an access code to a service provider, in accordance with some exemplary embodiments of the disclosure;

FIG. 1D is a schematic block diagram of a first hacking situation, in accordance with some exemplary embodiments of the disclosure;

FIG. 1E is a schematic block diagram of a second hacking situation, in accordance with some exemplary embodiments of the disclosure;

FIG. 2A is a flowchart of a method for periodic communication of an authentication server with a client, in accordance with some exemplary embodiments of the disclosure;

FIG. 2B is a flowchart of a method for periodic communication of an authentication server with a client when the client requests access code to a service, in accordance with some exemplary embodiments of the disclosure; and

FIG. 3 is a block diagram of the main entities in a system for providing secured access to data, in accordance with some embodiments of the disclosure.

### DETAILED DESCRIPTION

One technical problem dealt with by the disclosed subject matter is to provide a secured universal identity solution, or more generally an authentication mechanism. The solution needs to provide strong protection against adversaries, while overcoming the “secret-zero” problem, in which protecting each secret, such as a password, an access code or the like requires yet another secret which in turn needs to be protected.

Many of the currently available solutions, such as Secret Management Vaults, Key Management Systems (KMS) or Hardware Security Modules (HSM), attempt to secure secrets by making the secrets harder to steal, and in runtime determine whether the secrets can be given to the approaching entity. Since the common methodologies are intended for workloads, e.g., processes executed on servers such as cloud servers, wherein the processes are required to authenticate themselves to such security services using a token or another secret, this comes back to the secret-zero problem.

Some secret management solutions split the master credentials into a role identifier and some other secret information required to gain an access token to the secrets vault. However, the combination of role identifier and a secret identifier also creates a new secret zero, being the access token that now needs to be protected.

Some existing solutions, such as Conjur® system available from CyberArk® of Newton, Mass., US attempts to provide multi-factor authentication, using attributes available only to trusted containers, wherein multiple attributes need to be presented by an application in order to be authenticated. However, this approach is based on Two Factor Authentication (2FA), thereby introducing a new secret zero by a different name, since the multiple attributes, such as IP address range, securely random UUIDs, cryptographic keys, role, name or the like can be forged by a skilled hacker.

Another existing solutions, Vault® by HashiCorp® of San Francisco, Calif., USA, is designed to allow pre-existing systems to login to Vault with role identifier and secret identifier credentials, and retrieve a token with a specific set of attached capabilities, using wrapped tokens which enable to equip trusted entities with low-privileged and long-lived role credentials. However, this solution creates yet another “secret-zero” instead of the original one. Moreover, if an adversary can obtain the root token, then the adversary can compromise a large environment simultaneously, and even if detected, the revoke operation would cause substantial damage to the environment.

Further existing solutions, such as Cyber Armor® of Ticino, Switzerland, is based on code-DNA of workloads, which although it solves the secret-zero problem, is based on pattern matching, and hence can be easily exploited by skilled adversaries.

Thus, the disclosure relates to securely authenticating client requests for services and secret distribution without requiring an initial secret.

One technical solution of the disclosed subject matter relates to registering an application, a container, a computing platform or any other entity, referred to as “client”, with an authentication server, also referred to as “server”, for consuming a service provided by a party, which may be other than the authentication server. For example, the service may be a different cloud computing or cloud storage service. Upon authentication of the client with the server in relation to a particular service, the client is enabled to access the relevant service provider.

The term “token” used in the current disclosure is to be widely construed to cover any programming object, such as a class instance, a record, or the like, associated with a unique identifier. A token may also be configured to execute operations, such as spawning a new token.

The term “token rotation” used in the current disclosure is to be widely construed to cover any generation of a new token upon verification of a given previous token. The new token may depend upon the previous token, or be calculated regardless of the previous token.

Upon registration, a client may be provided with an initial token. The token may then be constantly rotated, wherein the client is required to send the token to the server every predetermined period of time, and also upon requesting access to a service. Upon receiving a token, with or without a service request, the server may verify the token and check if it is indeed the last token that has been sent to the client; invalidate the token; rotate the token; and send a new token to the client, which the client will use for the next communication. The server may also check that the token has been issued within the preceding predetermined time window, thereby verifying ongoing communication with the client.

If the client requests access to a service, then upon verification of the token, the server may provide the client with a temporary access code to the service with the third party. The client may then access the third party with the temporary access code directly without divulging a persistent access code to the third party. Additionally or alternatively, the temporary access code may be used by a proxy acting on behalf of the client and communicating with the third party. In some embodiments, the authentication server may serve as the proxy.

If a malicious party obtains the current token and attempts to use it, then whether the client or the malicious party has used the token before the other party, then upon the second attempt to use the token, the authentication server will issue a security alert to the client. Thus, even if the malicious party has used the token before the client had a chance to use the token, the malicious party can only do so once, within the predetermined time window between validations, and the client will get an alert the next time the client communicates with the authentication server, whether for periodic communication or requesting to access a service.

One technical effect of the disclosure provides for solving the secret-zero problem by securely allowing users to identify their machines, and authenticating client requests for services and secret distribution, without the need to maintain and protect a secret zero or introduce more credentials than needed.

Another technical effect of the disclosure relates to the token provided to the client being rotated periodically upon appropriate communication, thus even if a malicious party obtained a token, the malicious action is disabled if the client has used the token first. At worse, a malicious act may be discovered within at most a predetermined time period, since the client is configured to contact the server every such time period.

Yet another technical effect of the disclosure relates to the solution being useful in a cloud-native scenario, wherein the relevant Credential Service Provider (CSP) identity service infrastructure (e.g., AWS-IAM™/GCP-IAM™/Azure-Active Directory™) may provide the identity, e.g. the initial token. Hence, the disclosed subject matter may be cloud agnostic and independent of specific platform. Additionally or alternatively, the disclosed subject matter may also be used in a non-cloud-native environment, such as on-premise or private cloud. It will be appreciated that the disclosure can be used for managing identity for multi-cloud setups, and may prevent the need of working in silos with each different CSP, and configuring the same identities over and over for each service provider.

Yet another technical effect of the disclosure relates to the solution being easy and inexpensive to implement. Moreover, the solution is easy to upscale as more clients require services. Further, as additional services may become available and required, interfaces with such services may be implemented by the server such that a client can consume the services seamlessly.

Additional technical effects may be apparent to a person of ordinary skill in the art in view of the present disclosure.

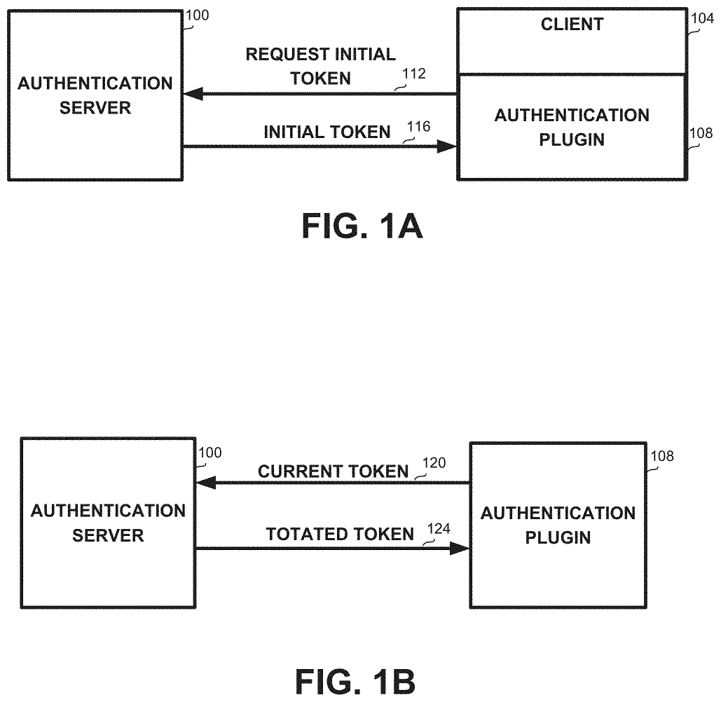

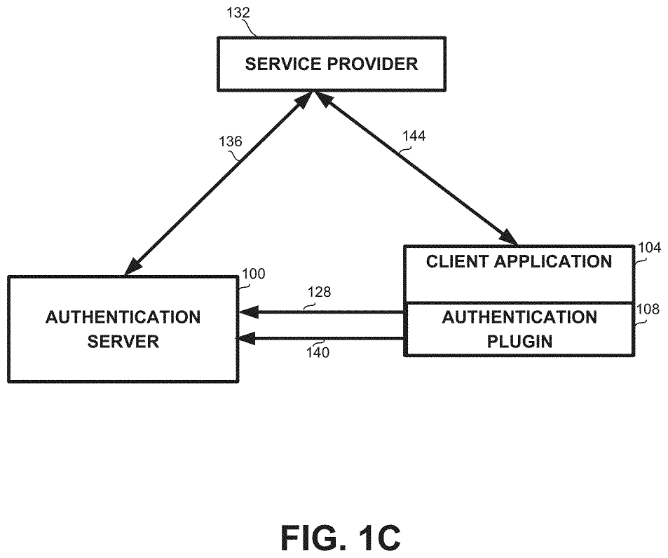

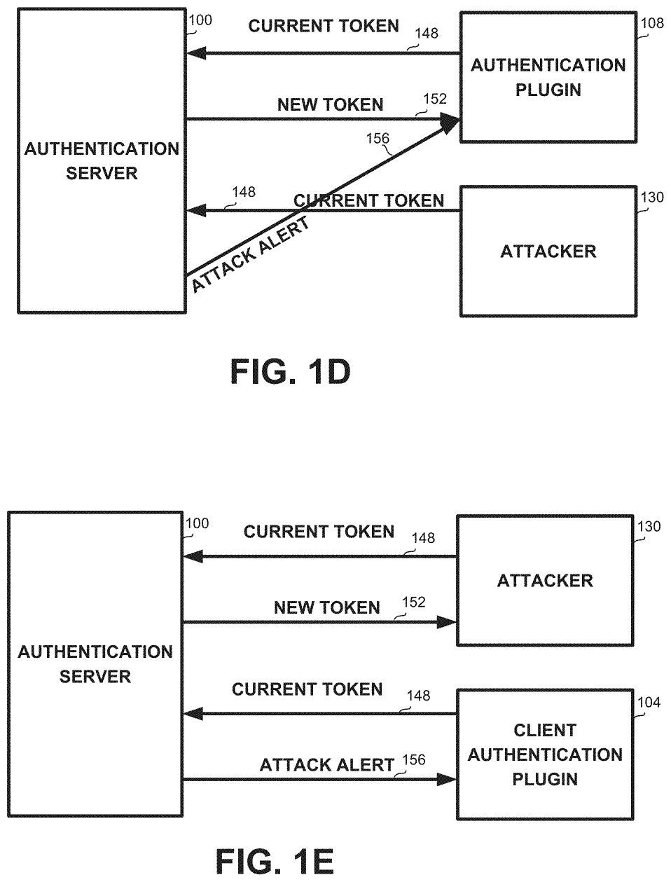

Referring now to FIG. 1A, showing a schematic block diagram of exchanging an initial token, in accordance with some exemplary embodiments of the disclosure.

A client 104 may be an application, a web application or the like, and may use third party services and their respective CSP identity service provided by one or more service provides. In some embodiments, client 104 may also be referred to as a computing platform configured to consume services. Client 104 may comprise an authentication component, implemented for example as authentication plugin 108, responsible for the communication with authentication server 100, including handling periodic communication, request and receive access codes for third party services, or the like. authentication plugin 108 may use a Software Development Kit (SDK) to access functionality of authentication server 100.

Upon registration, authentication plugin 108 may send a request 112 to authentication server 100 for an initial token associated with a particular service.

Authentication server 100 may then provide an initial token 116 as requested, which the client 104 is to use in the next communication with authentication server 100.

In alternative embodiments, an existing token within a client environment, referred to as a root token, may generate initial tokens for one or more clients 104, wherein during the first communication between client 104 and authentication server 100, authentication server 100 will accept this token as valid although received by the client through another client and not directly from the server. It will be appreciated that the new token may be generated by the existing token through the normal communication with the authentication server, and then handed to the new client. Thus, tokens within the client environment may be arranged in a hierarchy, wherein one or more tokens can spawn initial tokens for one or more further clients. This scheme is particularly useful for re-initializing the token after a client platforms reboots, loses connectivity, or the like, since client identification is performed within the client environment and does not require communication with authentication server 100.

The two token generation methods may be used as follows:

1. In a manual manner, when a human user configures and deploys a machine, the human user may request a token, the initial token may be created and provided to the user.

2. In an automatic mode, when a machine creates a client on another machine, the token of the new client may be received from the creating machine. The creating machine can give its own token to the new client, if the creating machine no longer needs to be identified. In other situations, the creating machine may have a root token, which may spawn a child token to be given to the new client. In further situations, for example when a hierarchy of machines is created, the creating machine may spawn a root token, which is adapted to spawn further tokens, and provide it to the new client. In either case, once a client obtains a token, it may be configured to start communicating with the server as disclosed below.

If the token is provided by authentication server 100, the token may be obtained by authentication server 100 in cooperation with the service provider.

Referring now to FIG. 1B, illustrating the periodic communication exchange between client 104 and authentication server 100, in accordance with some exemplary embodiments of the disclosure. Authentication plugin 108 may be configured to send current token 120 on behalf of client 104 to authentication server 100. Authentication server 100 may verify the received token, including verifying that the token is indeed the last token provided by authentication server 100 or the token initializer to client 104, and verifying that the last communication with client 104 was at most a predetermined period of time earlier. The period of time may be set, for example to be between about five minutes and about two hours, according to the user's risk management. The period of time may be selected such that it is long enough for a computing platform to boot or to restore communication in most cases, so that the computing platform is likely to form the next communication before the period of time has elapsed. On the other hand, the period of time may be selected to be short enough such that a malicious act may be discovered before significant damage has been done. Once the token is verified, authentication server 100 invalidates the token, rotates the token to generate a rotated token 124 and provides rotated token 124 to authentication plugin 108. In further embodiments, the maximal period of time for expiration may be set to be longer, but the client may be configured to initiate the actual rotation on shorter intervals, thereby achieving both goals: the expiration time is long enough for a computing platform to boot, while the short rotation time may provide for discovering malicious actions before significant damage has been done.

Referring now to FIG. 1C, illustrating a communication exchange between client 104 to authentication server 100 for obtaining an access code to a service provider 132, in accordance with some exemplary embodiments of the disclosure. Authentication plugin 108 may be configured to issue a request 128 for access code to a particular service provided by service provider 132. Request 128 may be supplemented by the current token as last provided by the authentication server. Upon verifying the current token, authentication server 100 may obtain, in agreement with service provider 132, a temporary access code for the service provided by service provider 132, and provide it in a message 140 to authentication plugin 108, together with a newly rotated token. Client 104 can then access service provider 132 with the temporary access code, for example via message 144, and receive the service.

Referring now to FIG. 1D, illustrating a first hacking situation within an environment in accordance with the disclosure.

The situation is of a malicious attacker 130 that obtained current token 148. Authentication plugin 108 uses token 148 as usual, by sending a message with token 148, for periodic communication with or for service request from authentication server 100. Authentication server 100 verifies token 148, invalidates it, and provides authentication plugin 108 with a rotated token 152. If token 148 was sent with a request for a temporary access code for a service, the temporary access code may be provided as well.

Malicious attacker 130 then also sends current token 148 to authentication server 100. However, token 148 has already been invalidated by authentication server 100. Therefore, authentication server 100 determines that an attack attempt has occurred, does not grant any access code nor a rotated token, but rather sends an attack alert to authentication plugin 108, thereby notifying the client of the attack attempt.

Referring now to FIG. 1E, illustration a second hacking situation within an environment in accordance with the disclosure.

The situation is again of a malicious attacker 130 that obtained current token 148. However, in this situation, malicious attacker 130 communicates with authentication server 100 before authentication plugin 108 does, and before the predetermined time has elapsed after token 138 was provided to authentication plugin 108. Thus, attacker 130 sends token 148 to authentication server 100, authentication server 100 verifies token 148, invalidates it, sends a rotated token 152 to attacker 130, and if requested also provides the required access code to a service.

Authentication plugin 108 then attempts to use token 148 as usual, by sending a message with the token, for periodic communication with or for service request from authentication server 100. Authentication server 100 determines that token 148 is invalid. Therefore, authentication server 100 determines that an attack attempt has occurred and sends an attack alert 156 to authentication plugin 108, thereby notifying the client of the attack attempt.

In the second case, some damage may be caused by attacker 130 between the time attacker 130 has sent token 148 and the time authentication plugin received attack alert 156, but the time window for the damage is limited by the predetermined time period the communications between authentication plugin 108 and authentication server 100.

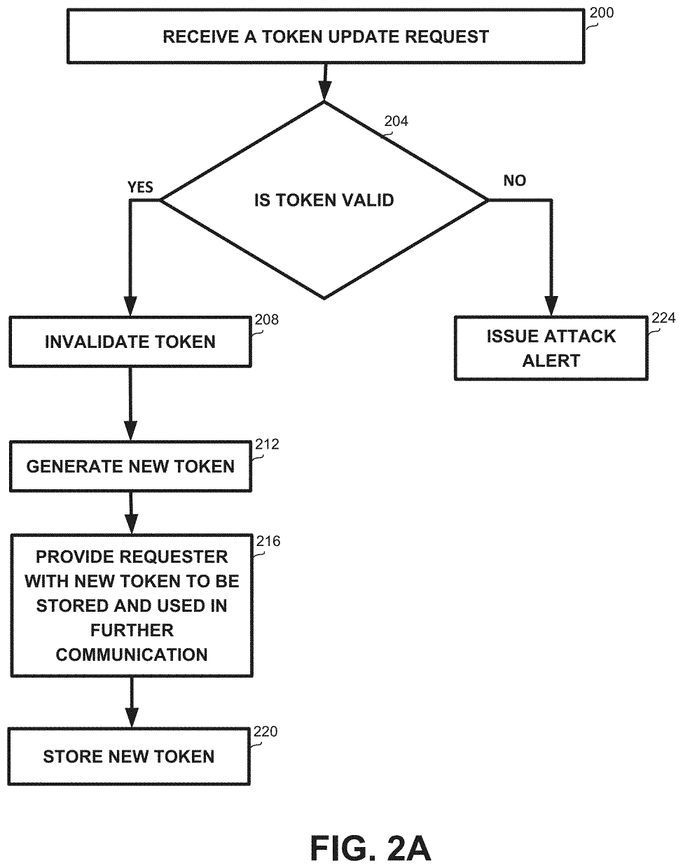

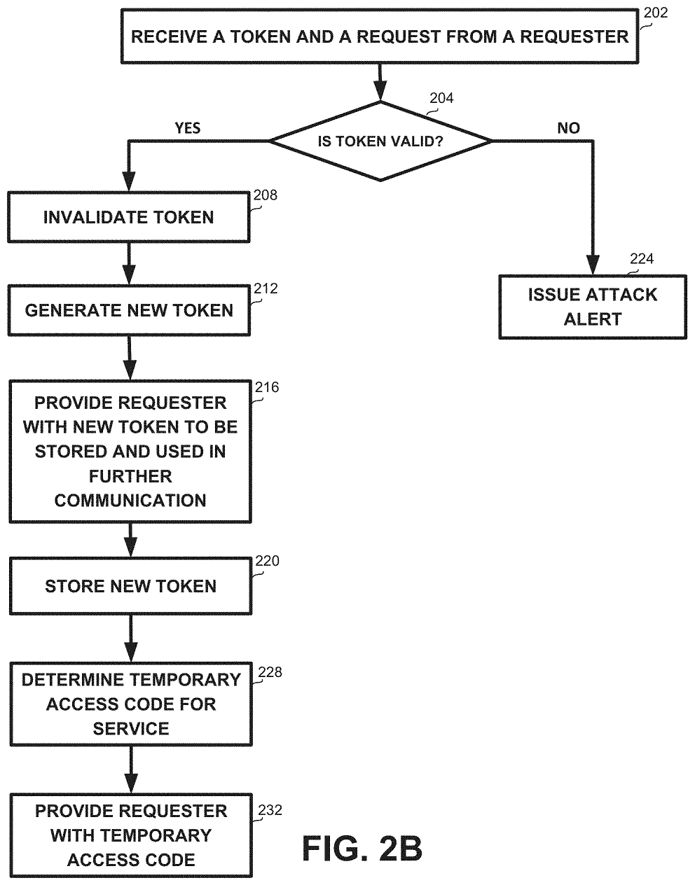

Referring now to FIG. 2A, showing a flow chart of steps in a method performed by an authentication server during periodic communication with a client, in accordance with some embodiments of the disclosure.

On step 200, a token update request may be received from a client, for example via a client plugin. The request may be received as part of the periodic communication between the client and the server, intended to verify that an attack may not succeed, or even if successful will be identified within the predetermined time period.

On step 204 the token may be verified for validity by the server. Verification may include checking that the token or the unique identifier corresponds to an identifier or to the token stored within the authentication server in association with the client and optionally with a particular service. Verification may also include verifying that the token was issued to the client not more than the predetermined period of time prior to receiving the periodic communication.

If the token was verified successfully then on step 208 the token may be invalidated, such that a further attempt to use it will fail.

On step 212 a new token may be generated for example by rotating, including computing or otherwise obtaining a new unique identifier. The rotated token may be created based on standard cryptography methods, such as symmetrical or asymmetrical encryption algorithms including but not limited to AES, 3DES, RSA, ECC. Additionally or alternatively, token rotation may be based on standard cryptography methods, such as random or pseudo-random methods.

On step 216 the rotated token may be provided to the client to be used on the next communication.

On step 220 the identifier or the new token may be stored by the server, together with the time it was provided to the client, for verifying the token that will be sent by the client on the next communication.

If the token was not verified, i.e., is determined to be invalid, an attack attempt may be determined, and on step 224 an attack alert may be issued to the client. The attach alert may include sending a message to a client or to a person associated with the client, notifying a third party associated with the request, if any, that an attack attempt has been detected and no access should be granted to the client or to another entity allegedly operating on behalf of the client, or the like.

Referring now to FIG. 2B, showing a flowchart of steps in a method performed by an authentication server when a client requests access code to a service, in accordance with some embodiments of the disclosure.

On step 202, a request for an access code to a service may be received from a requester, wherein the requester may be a client or an attacker attempting to perform a malicious action in association with the service.

On step 204 the token may be verified for validity as detailed above in association with FIG. 2A.

If the token is valid, then steps 208, 212, 216 and 220 may be performed as detailed above in association with FIG. 2A.

In addition, on step 228 the server may determine a temporary access code for receiving the service. The temporary access code may be valid for a predetermined period of time, such as between about one minute and about one hour. The temporary access code may be obtained in cooperation with the service provider. Alternatively, the temporary access code may be determined based on a scheme agreed with the service provider, such that when presented to the service provider, the service provider will provide the service.

On step 232 the server may provide the temporary access code to the client. The client can then request or consume the service, either directly by accessing the service provider, or by a proxy. The proxy may be the authentication server or any other proxy.

If the token is invalid, then as before, on step 224 an attack alert may be provided, and optionally additional actions may be taken, such as notifying the service provider of the attack.

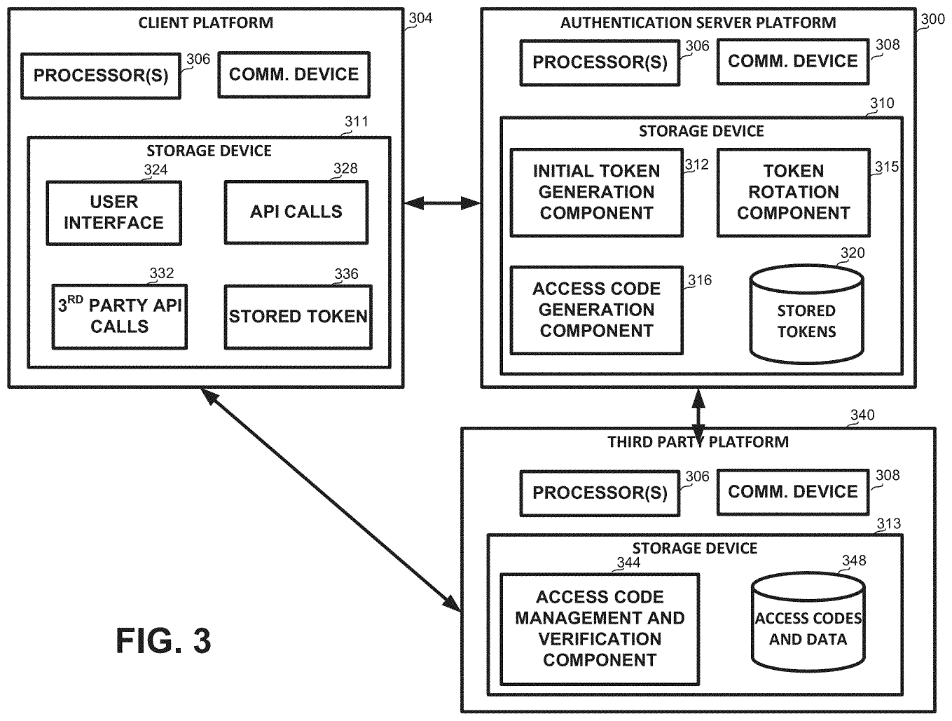

Referring now to FIG. 3, showing a block diagram of the main entities in an apparatus in accordance with some embodiments of the disclosure.

The system generally comprises authentication server platform 300 and client platform 304, communicating with third party platform 340.

It will be appreciated that authentication server platform 300 may be implemented as one or more computing platforms which may be operatively connected to each other. For example, one or more computing platforms, which may be implemented for example on a cloud computer, may be used. Other computing platforms may be a part of a computer network of an organization, and used for providing the required services within the organization. In other embodiments, all the functionality may be provided by one or more computing platforms all being a part of the organization network. Authentication server platform 300 may communicate with other computing platforms whether within the organization, in other organizations or with servers such as cloud servers via any communication channel, such as a Wide Area Network, a Local Area Network, intranet, Internet or the like.

Authentication server platform 300 may comprise one or more processors 306, which may be one or more Central Processing Units (CPU), microprocessors, electronic circuits, Integrated Circuits (IC) or the like. Processor 306 may be configured to provide the required functionality, for example by loading to memory and activating the software modules stored on storage device 310 detailed below.

It will also be appreciated that processor 306 may be implemented as one or more processors, whether located on the same computing platform or not. In some embodiments edge computing may also be exercised, in which some initial processing is performed by local computers while more resource consuming processing is performed on remote servers, cloud computers or the like.

Authentication server platform 300 may comprise communication device 308 for communicating with one or more client platforms 304, one or more third party platforms 340 or other platforms. Communication device 308 can be operative to communicate with other platforms using any equipment and protocol, such as Local Area Network, Wide Area Network, Wi-Fi, cellular, or the like.

Authentication server platform 300 may comprise a storage device 310, such as a hard disk drive, a Flash disk, a Random Access Memory (RAM), a memory chip, or the like. In some exemplary embodiments, storage device 310 may retain program code operative to cause processor 306 to perform acts associated with any of the modules listed below, or steps of the methods of FIG. 2A or FIG. 2B above. The program code may comprise one or more executable units, such as functions, libraries, standalone programs or the like, adapted to execute instructions as detailed below. Storage device 310 may comprise one or more storage devices which may be collocated or located at different places.

The program code may comprise one or more executable units, such as functions, libraries, standalone programs or the like, adapted to execute instructions as detailed below.

Client platform 304 and third party platform 340 may comprise one or more storage devices 311 and 313, respectively, one or more processors 306, and one or more communication devices 308 as detailed for authentication server platform 300.

Storage device 310 may comprise initial token generation component 312, for providing an initial token to a client regarding a service, upon starting a client or upon the client recovering from a failure.

Storage device 310 may comprise token rotation component 315 for verifying that a token provided by a client is indeed valid. If the token is valid, it is invalidated, a new token is generated, for example by rotating the last token, the new token may be stored and provided to the client.

Storage device 310 may comprise access code generation components 316 for generating, possibly in cooperation with third party platform 340, a temporary access code to be provided to the client, such that the client can access data stored on third party platform 340.

Storage device 310 may comprise stored tokens 320, for storing one or more tokens or unique identifiers associated with one or more clients and one or more services.

The components stored within storage device 311 of client platform 304 may be implemented within a plugin, as a separate executable, or the like, to be utilized by a client device such as a desktop, a laptop, a mobile device or the like.

Storage device 311 may comprise a user interface 324 for a user to ask for a new token when installing the client, for resetting a token, or the like. However, in some embodiments client platform 304 may be implemented without a user interface.

Storage device 311 may comprise Application Program Interface (API) calls 328 for calling different functionalities of the authentication server, such as requesting an initial token, rotating a token, requesting access to third party service, or the like.

Storage device 311 may comprise 3^{rd} party API calls 332 for receiving functionality or data from third party platform 340, such as accessing data stored thereon once a temporary access code is received from the authentication server.

Storage device 313 of third party platform 340 may comprise access code management and verification component 344, for cooperating with authentication server platform 300 in generating temporary access codes, and for verifying that a temporary access code provided by a client is valid, such that the required service can be provided.

Storage device 313 may comprise access code and data storage 348, for storing the temporary access codes relevant for clients, and the customer data to be provided.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Java, C++, C #, Phyton, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a non-transitory computer readable storage medium retaining program instructions configured to cause a processor to perform actions, which program instructions implement:
receiving, by a server, from a requester, a request and a token associated with a client;
determining whether that the token is valid, wherein said determining whether the token is valid comprises determining whether the token corresponds to a stored token provided by the server to the client at most a predetermined time period prior to said receiving;
subject to a determination that the token is valid:
providing to the requester a new token to be stored by the client and used in future communications;
storing the new token;
invalidating the token; and
providing the requester with access to client data stored with a third party, wherein said access is enabled by a temporary code to be used in communication with the third party; and
subject to a determination that the token is invalid: issuing an attack alert to the client.

2. The computer program product of claim 1, wherein the temporary code is to be provided by the client when communicating with the third party, whereby the client is enabled to access the third party directly without divulging a persistent access code to the third party that is usable in future connection sessions.

3. The computer program product of claim 1, wherein the temporary code is to be used by a proxy communicating with the third party on behalf of the client.

4. The computer program product of claim 1, wherein the predetermined time period is between two hours and five minutes.

5. The computer program product of claim 1, wherein the client is configured to initiate token update in a periodic manner at least once during the predetermined time period, wherein the token update comprises: providing a valid token to the server, invalidation, by the server, of the valid token, issuing, by the server, a second valid token, and transmitting the second valid token to the client.

6. The computer program product of claim 1, wherein the client is an application using a Software Development Kit (SDK) to access the server.

7. The computer program product of claim 1, wherein the program instructions further implement:
upon client configuration with the server in relation with the third party, providing by the server to the client an initializer token, the initializer token to be used as the token on a first communication with the server, regarding the third party; and
storing the initializer token.

8. The computer program product of claim 1, wherein the program instructions further implement:
providing an initializer token to the client by a parent process configuring the client in relation with the third party, the initializer token to be used as the token on a first communication with the server, regarding the third party.

9. The computer program product of claim 1, wherein the client is implemented on a computing platform selected from the group consisting of: a cloud computing platform, and an on-premise computing platform.

10. The computer program product of claim 1, wherein the server is implemented on a computing platform selected from the group consisting of: a cloud computing platform, and an on-premise computing platform.

11. A method for authenticating a client by a server, comprising:
receiving, by a server, from a requester, a request and a token associated with a client, the request related to accessing client data stored with a third party;
upon determining that the token does not correspond to a last token provided by the server to the client, or that the last token was provided by the server to the client more than a predetermined time period prior to said receiving issuing an attack alert to the client.

12. A method for authenticating a client by a server, comprising:
receiving, by a server, from a requester, a request and a token associated with a client;
determining whether that the token is valid, wherein said determining whether the token is valid comprises determining whether the token corresponds to a stored token provided by the server to the client at most a predetermined time period prior to said receiving;
subject to a determination that the token is valid:
providing to the requester a new token to be stored by the client and used in future communications;
storing the new token;
invalidating the token; and
providing the requester with access to client data stored with a third party, wherein said access is enabled by a temporary code to be used in communication with the third party; and
subject to a determination that the token is invalid: issuing an attack alert to the client.

13. The method of claim 12, wherein the temporary code is to be provided by the client when communicating with the third party, whereby the client is enabled to access the third party directly without divulging a persistent access code to the third party that is usable in future connection sessions.

14. The method of claim 12, wherein the predetermined time period is between two hours and five minutes.

15. The method of claim 12, wherein the client is configured to initiate token update in a periodic manner at least once during the predetermined time period, wherein the token update comprises: providing a valid token to the server, invalidation, by the server, of the valid token, issuing, by the server, a second valid token, and transmitting the second valid token to the client.

16. The method of claim 12, further comprising:
upon client configuration with the server in relation with the third party, providing by the server to the client an initializer token, the initializer token to be used as the token on a first communication with the server, regarding the third party; and
storing the initializer token.

17. The method of claim 12, further comprising:
providing an initializer token to the client by a parent process configuring the client in relation with the third party, the initializer token to be used as the token on a first communication with the server, regarding the third party.

18. A computerized apparatus having a processor, the processor being adapted to perform the steps of:
receiving, by a server, from a requester, a request and a token associated with a client;
determining whether that the token is valid, wherein said determining whether the token is valid comprises determining whether the token corresponds to a stored token provided by the server to the client at most a predetermined time period prior to said receiving;
subject to a determination that the token is valid:
providing to the requester a new token to be stored by the client and used in future communications;
storing the new token;
invalidating the token; and
providing the requester with access to client data stored with a third party, wherein said access is enabled by a temporary code to be used in communication with the third party; and
subject to a determination that the token is invalid: issuing an attack alert to the client.

19. The apparatus of claim 18, wherein the processor is further adapted to perform the steps of:
receiving, by a server, from a requester, a request and a token associated with a client, the request related to accessing client data stored with a third party;
upon determining that the token does not correspond to a last token provided by the server to the client, or that the last token was provided by the server to the client more than a predetermined time period prior to said receiving issuing an attack alert to the client.

20. The apparatus of claim 18, wherein
the client is implemented on a computing platform selected from the group consisting of: a cloud computing platform, and an on-premise computing platform and wherein
the server is implemented on a computing platform selected from the group consisting of: a cloud computing platform, and an on-premise computing platform.
